(19) United States
(12) Patent Application Publication
(10) Pub. No.: US 2005/0269479 A1
(43) Pub. Date: Dec. 8, 2005

(54) Bracket structure and electronic apparatus

(75) Inventors: Ching Sung Yeh, Taipei (TW); Chih Sheng Tsai, Taipei (TW)

Correspondence Address: BACON & THOMAS, PLLC, 625 SLATERS LANE, FOURTH FLOOR, ALEXANDRIA, VA, 22314, US

(73) Assignee: ASUSTeK COMPUTER INC., Taipei (TW)

(21) Appl. No.: 11/025,917

(22) Filed: Jan. 3, 2005

(30) Foreign Application Priority Data
Jun. 3, 2004 (TW) 093116038

(51) Int. Cl. E05D 15/10

(52) U.S. Cl. 248/457

(57) ABSTRACT

A bracket structure is for supporting a housing. The bracket structure includes a bracket body, and a roller set. In this case, a first side of the bracket body is pivoted on the housing. A second side of the bracket body is disposed opposite to the first side, and the roller set is disposed on the second side. An electronic apparatus with the bracket structure is also provided.

### BACKGROUND OF THE INVENTION

1. Field of Invention

The invention relates to a bracket structure and an electronic apparatus. In particular, the invention relates to a bracket structure for adjusting the angle of an electronic apparatus and the electronic apparatus thereof.

2. Related Art

The display has been an important output device of the computer all the time. Since the planar display has such advantages as low radiation, low power consumption, and occupying little space, it is becoming popular among consumers.

As shown in FIG. 1, a conventional planar display 1 includes a panel 11, a bracket body 13, and a pivot 12. The bracket body 13 is connected to the back of the panel 11 via the pivot 12 to press against the desk and support the panel 11, preventing it from falling.

If a user wants to adjust the angle of the panel 11, he or she usually has to hold the panel 11 and the bracket body 13 with both hands and exerts force on them to rotate the angle between the bracket body 13 and the panel 11 until a desired angle is reached. However, this way of adjusting the angle is very inconvenient for users.

It is therefore an important subjective of the invention to provide a bracket structure and an electronic apparatus, which can prevent the user's inconvenience for adjusting the angle of the panel.

### SUMMARY OF THE INVENTION

In view of the foregoing, the invention is to provide a bracket structure, which includes a roller for the user's convenience to adjust the distance and relative height between a display and a host using a single hand, and an electronic apparatus with the bracket structure.

To achieve the above, a bracket structure of the invention is for supporting a housing and includes a bracket body and a roller set. A first side of the bracket body is pivoted on the housing. A second side of the bracket body is disposed opposite to the first side, and the roller set is disposed on the second side.

To achieve the above, an electronic apparatus of the invention includes a display, a bracket, and a roller. A first side of the bracket is pivoted on the display. A second side of the bracket is disposed opposite to the first side, and the roller is disposed on the second side.

As mentioned above, the bracket structure and electronic apparatus of the invention have a roller. In comparison with the prior art, the invention enables the user to push the bracket body or housing with a single hand, thereby rolling the roller in the bracket body to move the bracket body back and forth, for adjusting the height and angle of the display panel. Here, one does not need to use both hands. Using the roller, the adjustment of the display panel becomes much easier.

### BRIEF DESCRIPTION OF THE DRAWINGS

The invention will become more fully understood from the detailed description given herein below illustration only, and thus is not limitative of the present invention, and wherein:

FIG. 1 is a schematic view of the conventional planar display;

FIG. 2 is a schematic view of a bracket structure and an electronic apparatus according to an embodiment of the invention;

FIG. 3 is a schematic view of a bracket body and a roller according to the embodiment of the invention;

FIG. 4 is another schematic view of the bracket structure and electronic apparatus according to the embodiment of the invention; and

FIG. 5 is a schematic view of the actions of the bracket structure and electronic apparatus according to the embodiment of the invention.

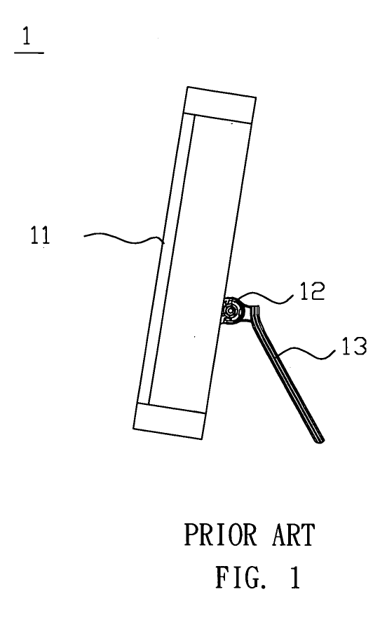

### DETAILED DESCRIPTION OF THE INVENTION

The present invention will be apparent from the following detailed description, which proceeds with reference to the accompanying drawings, wherein the same references relate to the same elements.

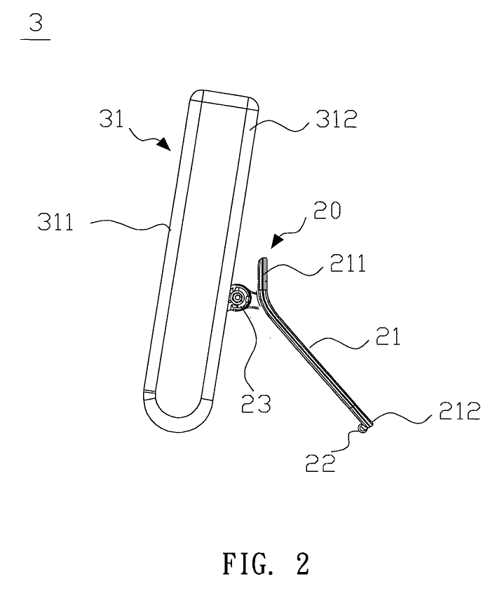

In the following, a bracket structure according to a preferred embodiment of the disclosed will be described with reference to FIGS. 2 to 5.

In this embodiment, a bracket structure 20 of a liquid crystal display (LCD) is taken as an example. Of course, the bracket structure 20 is not limited to the one for the LCD and can be installed in other planar displays or desktop electronic devices, such as the tablet PC, pen inputting board, and the likes. As shown in FIG. 2, the electronic apparatus 3 includes a display 31, which has a display panel 311 and a housing 312. The housing 312 covers at least one part of the display panel 311.

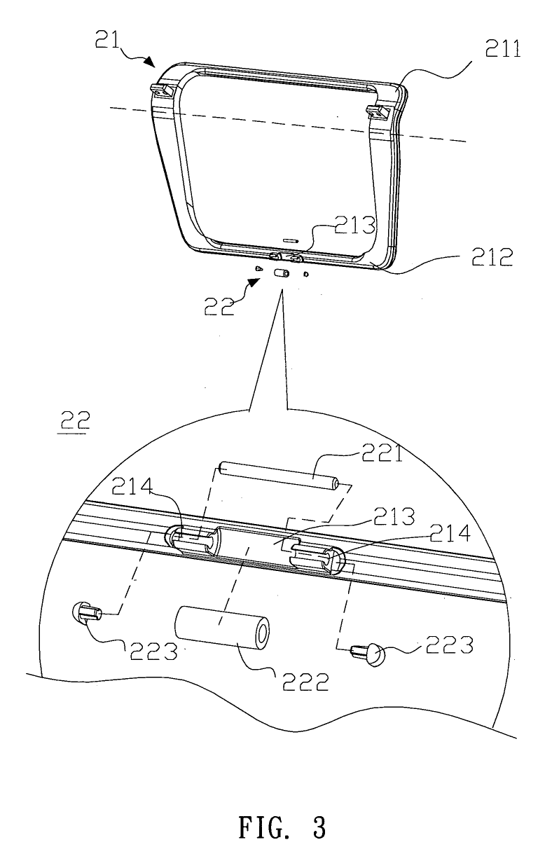

As shown in FIG. 2, the bracket structure 20 is used to support the housing 312. Please refer to FIG. 3. The bracket structure 20 includes a bracket body 21 and a roller set 22.

With reference to FIGS. 3 to 5, a first side 211 of the bracket body 21 is pivoted on the housing 312. A second side 212 of the bracket body 21 is disposed opposite to the first side 211. When one pushes the bracket body 21 or the housing 312, the roller set 22 starts rolling.

In this embodiment, the bracket structure 20 further includes at least one pivot 23. The pivot 23 is connected to the housing 312 and the bracket body 21 and enables the bracket body 21 to open with submitting to the housing 312. In this case, the pivot 23 provides a frictional force to maintain the angle between the bracket body 21 and the housing 312. Therefore, the bracket structure 20 would not lose its supporting force when the angle between the bracket body 21 and the housing 312 becomes too large.

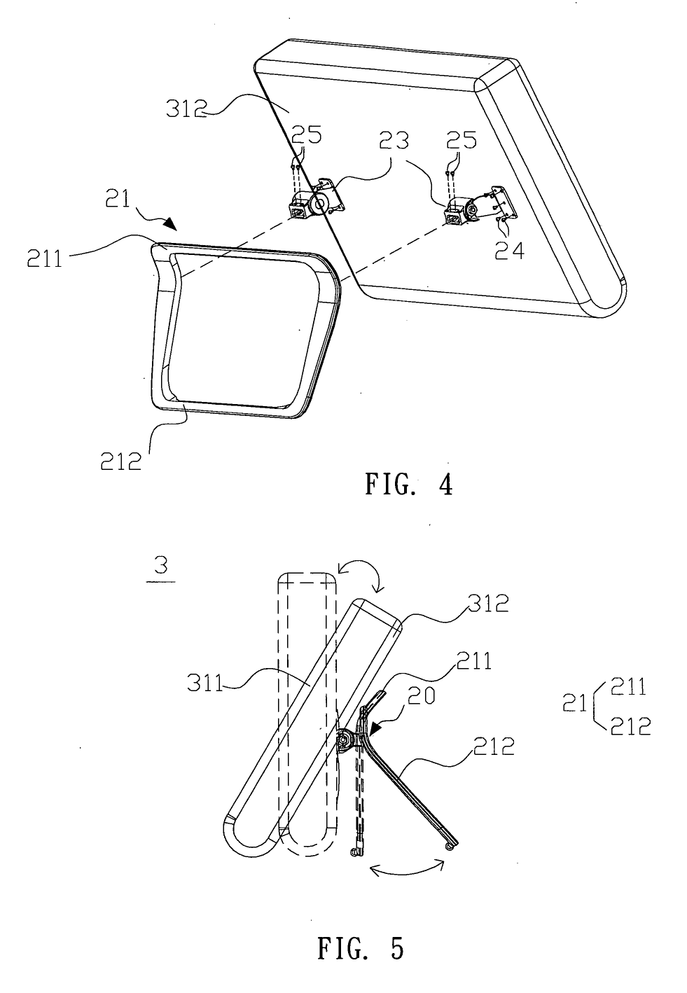

Moreover, the bracket structure 20, as shown in FIG. 4, further includes a first screw 24 going through one part of the pivot 23 and connecting the pivot 23 and the housing 312, thereby fixing the pivot 23 onto the housing 312. The bracket structure 20 can also include a second screw 25 to fixing one side of the pivot 23 on the bracket body 21.

Referring to FIG. 3, the roller set 22 is disposed on a second side 212 of the bracket body 21. In this embodiment, the second side 212 includes an opening 213 and two grooves 214. The roller set 22 is accommodated in the opening 213, and the grooves 214 are formed adjacent to the opening 213. The roller set 22 includes a roller axis 221 and a roller 222. The roller axis 221 goes through the roller 222 and wedges in the grooves 214, so that the roller 22 can rotate freely about the roller axis 221 in the opening 213.

Besides, the roller set 22 can include two stopping portions 223 connected to the grooves 214 to avoid the roller axis 21 from sliding out of the grooves 214 when the roller 222 is rotating. This mechanism can increase the stability of the roller 222.

With reference to FIG. 5, when a user wants to adjust the height of the display panel 311 and its distance to the user, he or she uses one hand to push the bracket body 21 or the housing 312 backward so that the roller 222 in the bracket body 21 starts rolling. The second side 212 of the bracket body 21 is brought backward to lower the height of the display panel 311. At the same time, the angle of the display panel 311 increases for the convenience of the user's viewing. The adjusted bracket structure 20 maintains the angle of the display panel 311 using a frictional force provided by the pivot 23 between the bracket body 21 and the housing 312.

Hereinafter, an electronic apparatus 3 according to a preferred embodiment of the disclosed will be described with reference to FIGS. 2 to 5.

With reference to FIG. 2, the electronic apparatus 3 includes a display 31, a bracket body 21, and a roller set 22. The display 31 has a display panel 311 and a housing 312 covering at least some part of the display panel 311.

In this embodiment, the electronic apparatus 3 is, for example, an LCD. Of course, the electronic apparatus 3 can be other planar displays or desktop electronic devices, such as the tablet PC, pen inputting board, and the likes.

The bracket body 21 and the roller set 22 here constitute the bracket structure 20 mentioned previously. With reference to FIGS. 3 to 5, a first side 211 of the bracket body 21 is pivoted on the housing 312. A second side 212 of the bracket body 21 is disposed opposite to the first side 211. The roller set 22 is disposed on the second side 212. When one pushes the bracket body 21 or the housing 312, the roller set 22 starts rolling.

In this embodiment, the electronic apparatus 3 further includes at least one pivot 23. The pivot 23 is connected to the housing 312 and the bracket body 21 and enables the bracket body 21 to open with submitting to the housing 312. In this case, the pivot 23 provides a frictional force to maintain the angle between the bracket body 21 and the housing 312. Therefore, the bracket structure 20 would not lose its supporting force when the angle between the bracket body 21 and the housing 312 becomes too large.

Moreover, the electronic apparatus 3, as shown in FIG. 4, further includes a first screw 24 going through one part of the pivot 23 and connecting the pivot 23 and the housing 312, thereby fixing the pivot 23 onto the housing 312. The bracket structure 20 can also include a second screw 25 to fixing one side of the pivot 23 on the bracket body 21.

Referring to FIG. 3, the roller set 22 is disposed on a second side 212 of the bracket body 21. In this embodiment, the second side 212 includes an opening 213 and two grooves 214. The roller set 22 is accommodated in the opening 213, and the grooves 214 are formed adjacent to the opening 213. The roller set 22 includes a roller axis 221 and a roller 222. The roller axis 221 goes through the roller 222 and wedges in the grooves 214, so that the roller 22 can rotate freely about the roller axis 221 in the opening 213.

Besides, the roller set 22 can include two stopping portions 223 connected to the grooves 214 to avoid the roller axis 21 from sliding out of the grooves 214 when the roller 222 is rotating. This mechanism can increase the stability of the roller 222.

With reference to FIG. 5, when a user wants to adjust the height of the display panel 311 and its distance to the user, he or she uses one hand to push the bracket body 21 or the housing 312 backward so that the roller 222 in the bracket body 21 starts rolling. The second side 212 of the bracket body 21 is brought backward to lower the height of the display panel 311. At the same time, the angle of the display panel 311 increases for the convenience of the user's viewing. The adjusted bracket structure 20 maintains the angle of the display panel 311 using a frictional force provided by the pivot 23 between the bracket body 21 and the housing 312.

In summary, the bracket structure and electronic apparatus of the invention have a roller. In comparison with the prior art, the invention enables the user to push the bracket body or housing with a single hand, thereby rolling the roller in the bracket body to move the bracket body back and forth, for adjusting the height and angle of the display panel. Herein, one does not need to use both hands. Using the roller, the adjustment of the display panel becomes much easier.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

1. A bracket structure for supporting a housing, comprising:
a bracket body having a first side pivoted on the housing and having a second side disposed opposite to the first side; and
a roller set disposed on the second side.

2. The bracket structure of claim 1, further comprising:
at least a pivot connected to the housing and the bracket body, wherein the pivot enables the bracket body to open with submitting to the housing.

3. The bracket structure of claim 2, further comprising:
a first screw going through one part of the pivot and connecting the pivot and the housing.

4. The bracket structure of claim 1, wherein the roller set rolls when one of the bracket body and the housing is pushed.

5. The bracket structure of claim 1, wherein the second side comprises an opening and two grooves, the grooves are formed adjacent to the opening.

6. The bracket structure of claim 5, wherein the roller set comprises a roller axis and a roller, the roller is accommodated in the opening, and the roller axis goes through the roller and wedges in the grooves.

7. The bracket structure of claim 6, wherein the roller further comprises two stopping portions to prevent the roller axis from sliding out of the grooves.

8. An electronic apparatus, comprising:
a display;
a bracket having a first side pivoted on the display and a second side disposed opposite to the first side; and
a roller set disposed on the second side.

9. The electronic apparatus of claim 8, wherein the display has a display panel and a housing covering at least part of the display panel.

10. The electronic apparatus of claim 9, further comprising:
at least a pivot connected to the housing and the bracket body, wherein the pivot enables the bracket body to open with submitting to the housing.

11. The electronic apparatus of claim 10, further comprising:
a first screw going through one part of the pivot and connecting the pivot and the housing.

12. The electronic apparatus of claim 9, wherein the roller set rolls when one of the bracket body and the housing is pushed.

13. The electronic apparatus of claim 8, wherein the second side comprises an opening and two grooves, the grooves are formed adjacent to the opening.

14. The electronic apparatus of claim 13, wherein the roller set comprises a roller axis and a roller, the roller is accommodated in the opening, and the roller axis goes through the roller and wedges in the grooves.

15. The electronic apparatus of claim 14, wherein the roller further comprises two stopping portions to prevent the roller axis from sliding out of the grooves.
